(19) United States
(12) Patent Application Publication
(10) Pub. No.: US 2020/0231235 A1
(43) Pub. Date: Jul. 23, 2020

(54) Mounting for Folding Lock

(71) Applicant: Sheng Yung Lock Industrial Co., Ltd., Changhua County (TW)

(72) Inventor: Cheng-Yi Yang, Changhua County (TW)

(21) Appl. No.: 16/371,006

(22) Filed: Mar. 31, 2019

(30) Foreign Application Priority Data
Jan. 23, 2019 (TW) 108201108

(51) Int. Cl. B62H 5/00; E05B 71/00

(52) U.S. Cl. CPC B62H 5/00; E05B 71/00

(57) ABSTRACT

A mounting contains a holder configured to accommodate a folding lock and including a body, a fastener, a movable cover, and a latch. The body includes a backing, a first stopping fence, a second stopping fence, a holding portion, and an accommodation space, wherein the first stopping fence has a first rotatable connection portion, and the second stopping fence has a second rotatable connection portion and a guide portion. The fastener is rotatably connected with the second rotatable connection portion and is rotated to a fastening position and an unfastening position. The movable cover includes a first fringe and a second fringe, wherein the first fringe has a third rotatable connection portion, and the second fringe has a fixer. The latch is mounted on the guide portion of the second stopping fence and is movable between a locking position and an unlocking position.

### FIELD OF THE INVENTION

The present invention relates to a mounting configured to accommodate a folding lock and to be fixed on a bicycle frame.

### BACKGROUND OF THE INVENTION

A conventional folding lock for a bicycle is disclosed in TW Patent No. M513257 and contains a head portion and a collapsible portion. The collapsible portion includes multiple posts, a coupling rod, and a moving column. The coupling rod is connected on a first side of the head portion, the moving column is movably locked or unlocked on a second side of the head portion, and the multiple posts are rotatably expanded to produce a loop configured to lock a bicycle.

An angle adjustment structure of a bicycle rack is disclosed in TW Patent No. M380269, the bicycle rack is mounted on a bicycle frame and contains a body and a fixing plate rotatably connected with the body and fixed on the bicycle frame, such as a down tube. The body has an accommodation space configured to accommodate a folding lock, and the body is rotated leftward or a rightward relative to the fixing plate. However, the body is rotated to touch or block a top tube as fixing or removing the folding lock.

In addition, when the head portion is faced upward, a weight of the folding lock is not balanced and causes vibration.

A mounting of a bicycle lock is disclosed in CN203753285U and is applied to lock a bicycle on the mounting by ways of a rotatable fastener in an L shape. However, an orifice of the rotatable fastener cannot engage with a protrusion of a second protective column securely, and multiple bosses of the rotatable fastener cannot be retained in a plurality of recesses on two sides of the bicycle lock respectively, thus removing the bicycle lock from the mounting easily.

The present invention has arisen to mitigate and/or obviate the afore-described disadvantages.

### SUMMARY OF THE INVENTION

One aspect of the present invention is to provide a mounting which contains the second opening and the first opening, wherein a width of each of the second opening and the first opening is more than that of the conventional opening so that the folding lock is fixed or removed easily and quickly.

To obtain the above aspect, a mounting provided by a first embodiment of the present invention contains a holder configured to accommodate a folding lock and including: a body, a fastener, a movable cover, and a latch.

The body includes a backing, a first stopping fence extending from a first side of the backing, a second stopping fence extending from a second side of the backing opposite to the first side of the backing, a holding portion extending from a bottom of backing, and an accommodation space defined by the backing, the first stopping fence, the second stopping fence, and the holding portion so as to accommodate the folding lock; the holding portion accommodating a bottom of the folding lock. The first stopping fence has a first rotatable connection portion, and the second stopping fence has a second rotatable connection portion and a guide portion.

The fastener is rotatably connected with the second rotatable connection portion of the second stopping fence and is rotated to a fastening position and an unfastening position.

The movable cover includes a first fringe and a second fringe, wherein the first fringe has a third rotatable connection portion which is rotatably connected with the first rotatable connection portion of the first stopping fence so that the movable cover is rotatably closed or opened; wherein the second fringe has a fixer extending outward so that when the movable cover is rotatably closed, the fixer fastens with the fastener at the fastening position.

The latch is mounted on the guide portion of the second stopping fence and is movable between a locking position and an unlocking position. When the latch is located at the locking position, the latch stops the fastener being rotated to the unfastening position. When the latch is located at the unlocking position, the latch allows the fastener to be rotated to the fastening position.

### BRIEF DESCRIPTION OF THE DRAWINGS

FIG. 1 is a perspective view showing the assembly of a mounting for a folding lock according to a first embodiment of the present invention.

FIG. 2 is a perspective view showing the application of the mounting for the folding lock according to the first embodiment of the present invention.

FIG. 3 is a perspective view showing the exploded components of the mounting for the folding lock according to the first embodiment of the present invention.

FIG. 4 is a perspective view showing the assembly of a part of the mounting for the folding lock according to the first embodiment of the present invention.

FIG. 5 is a perspective view showing the operation of the mounting for the folding lock according to the first embodiment of the present invention.

FIG. 6 is another perspective view showing the assembly of a part of the mounting for the folding lock according to the first embodiment of the present invention.

FIG. 7 is a cross sectional view showing the operation of a part of the mounting for the folding lock according to the first embodiment of the present invention.

FIG. 8 is still another perspective view showing the assembly of a part of the mounting for the folding lock according to the first embodiment of the present invention.

FIG. 9 is a cross-sectional perspective view showing the operation of a part of the mounting for the folding lock according to the first embodiment of the present invention.

FIG. 10 is a cross sectional view showing the operation of a part of the mounting for the folding lock according to the first embodiment of the present invention.

FIG. 11 is another cross sectional view showing the operation of a part of the mounting for the folding lock according to the first embodiment of the present invention.

FIG. 12 is also another cross sectional view showing the operation of a part of the mounting for the folding lock according to the first embodiment of the present invention.

FIG. 13 is still another cross sectional view showing the operation of a part of the mounting for the folding lock according to the first embodiment of the present invention.

FIG. 14 is a perspective view showing the assembly of a part of the mounting for the folding lock according to the first embodiment of the present invention.

FIG. 15 is another cross sectional view showing the operation of a part of the mounting for the folding lock according to the first embodiment of the present invention.

FIG. 16 is also another cross sectional view showing the operation of a part of the mounting for the folding lock according to the first embodiment of the present invention.

FIG. 17 is a perspective view showing the operation of a part of the mounting for the folding lock according to the first embodiment of the present invention.

FIG. 18 is a perspective view showing the assembly of a mounting for a folding lock according to a second embodiment of the present invention.

FIG. 19 is a perspective view showing the operation of a mounting for a folding lock according to a third embodiment of the present invention.

FIG. 20 is another perspective view showing the operation of the mounting for the folding lock according to the third embodiment of the present invention.

FIG. 21 is also another perspective view showing the operation of the mounting for the folding lock according to the third embodiment of the present invention.

### DETAILED DESCRIPTION OF THE PREFERRED EMBODIMENTS

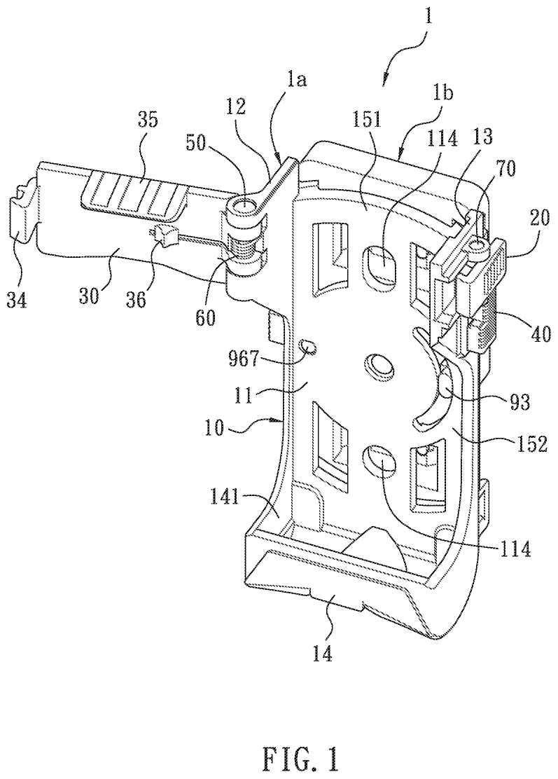

With reference to FIGS. 1 to 3, a mounting 1 according to a first embodiment of the present invention comprises a holder 1a configured to accommodate a folding lock 2, and the holder 1a includes a body 10, a fastener 20, a movable cover 30, and a latch 40.

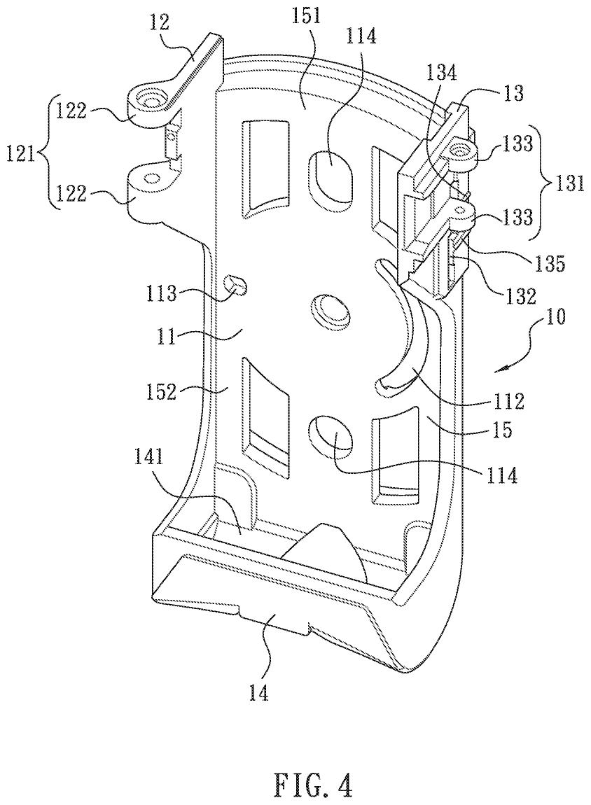

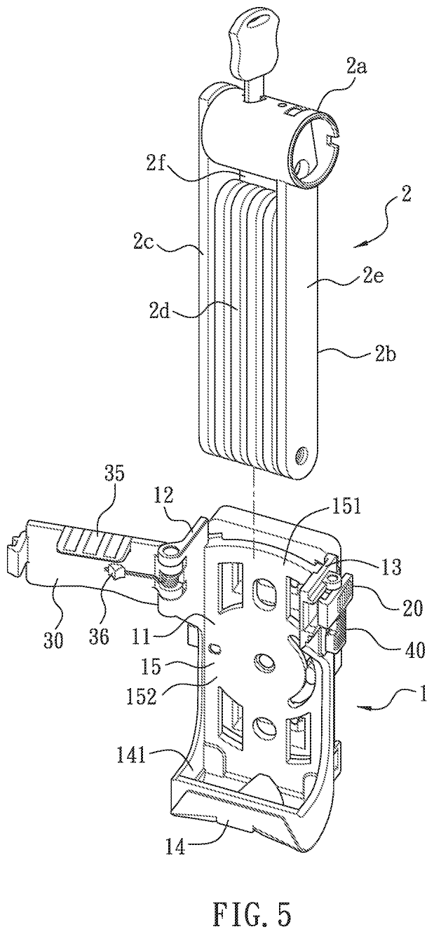

Referring to FIG. 4, the body 10 includes a backing 11, a first stopping fence 12 extending from a first side of the backing 11, a second stopping fence 13 extending from a second side of the backing 11 opposite to the first side of the backing 11, a holding portion 14 extending from a bottom of backing 11, and an accommodation space 15 defined by the backing 11, the first stopping fence 12, the second stopping fence 13, and the holding portion 14 so as to accommodate the folding lock 2. The accommodation space 15 has a first opening 151 and a second opening 152 which both communicate with the accommodation space 15. A receiving groove 141 is defined by the holding portion 14 and the backing 11 and is a part of the accommodation space 15 so as to partially receive the folding lock 2. The folding lock 2 includes a head portion 2a and a collapsible portion 2b. As shown in FIG. 5, a shape and a size of the receiving groove 141 correspond to a bottom of the collapsible portion 2b so that the receiving groove 141 accommodates the bottom of the collapsible portion 2b. The first stopping fence 12 has a first rotatable connection portion 121 formed thereon, and the second stopping fence 13 has a second rotatable connection portion 131 and a guide portion 132.

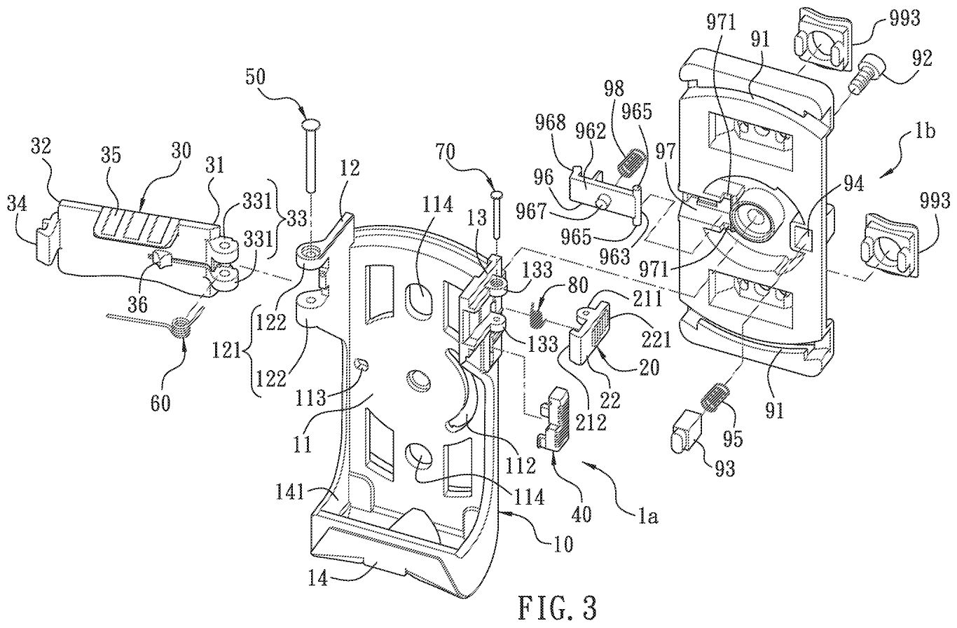

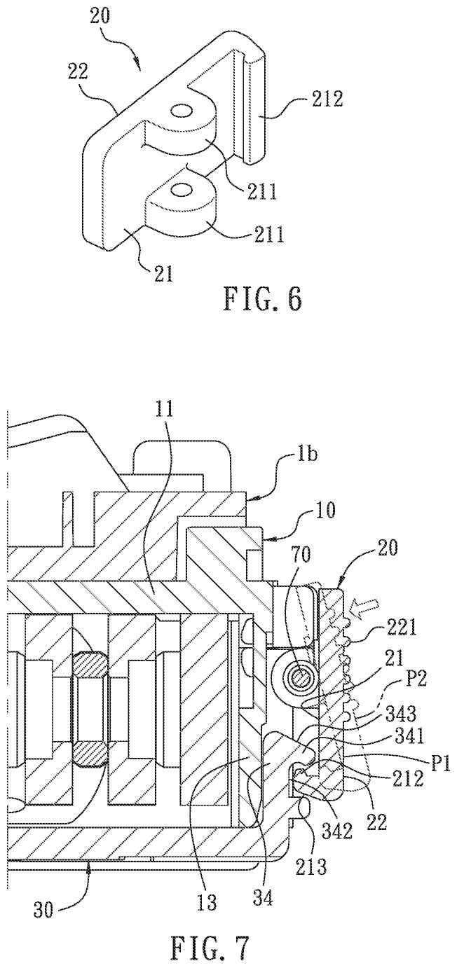

As illustrated in FIGS. 3 and 6, the fastener 20 is rotatably connected with the second rotatable connection portion 131 of the second stopping fence 13 and is rotated to a fastening position P1 and an unfastening position P2, as shown in FIG. 7.

With reference to FIGS. 3 and 4, the movable cover 30 includes a first fringe 31 and a second fringe 32, wherein the first fringe 31 has a third rotatable connection portion 33 which is rotatably connected with the first rotatable connection portion 121 of the first stopping fence 12 so that the movable cover 30 is rotatably closed or opened. In this embodiment, the movable cover 30 is located near a top of the second opening 152. The second fringe 32 has a fixer 34 extending outward so that when the movable cover 30 is rotatably closed, the fixer 34 fastens with the fastener 20 at the fastening position P1, as shown in FIG. 7.

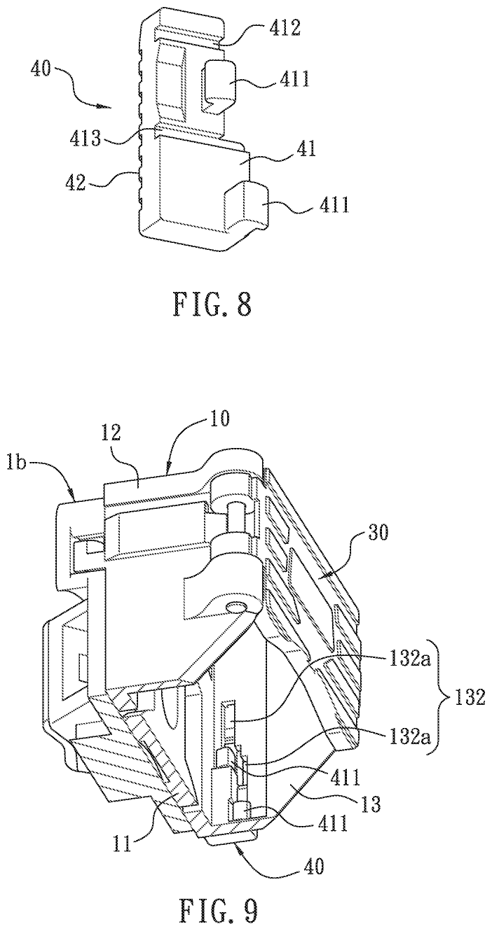

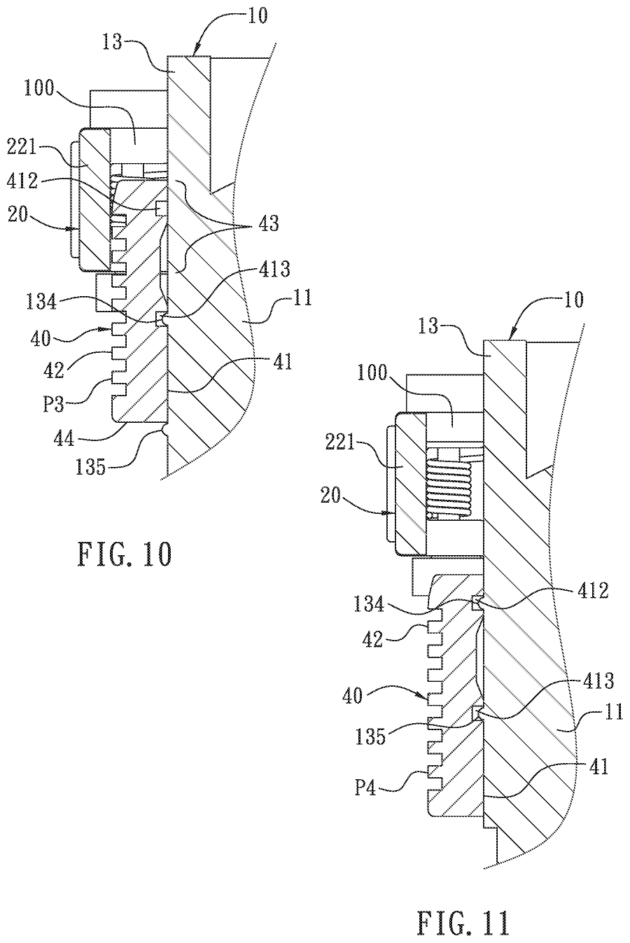

Referring to FIGS. 8 and 9, the latch 40 is mounted on the guide portion 132 of the second stopping fence 13 and is movable between a locking position P3 and an unlocking position P4. As shown in FIGS. 10 and 11, when the latch 40 is located at the locking position P3, it stops the fastener 20 being rotated to the unfastening position P2. When the latch 40 is located at the unlocking position P4, it allows the fastener 20 to be rotated to the fastening position P2.

As illustrated in FIG. 4, the first rotatable connection portion 121 has two opposite first tabs 122 extending from the first stopping fence 12. As shown in FIG. 3, the third rotatable connection portion 33 has two opposite second tabs 331 extending from the first fringe 31 of the movable cover 30, and the holder 1a further includes a first rotary shaft 50 configured to rotatably connect with the two first tabs 122 and the two second tabs 331 so that the movable cover 30 is rotated relative to the first stopping fence 12.

With reference to FIG. 3, the holder 1a further includes a first torsion spring 60 fitted on the first rotary shaft 50, wherein a first end of the first torsion spring 60 is inserted into the first stopping fence 12, and a second end of the first torsion spring 60 abuts against the movable cover 30 so that when the movable cover 30 is rotated to the unfastening position P2 after pressing the fastener 20, the movable cover 30 is pushed by the first torsion spring 60 to open automatically, as shown in FIG. 1.

Referring to FIGS. 3 and 4, the second rotatable connection portion 131 has two opposite third tabs 133 extending from the second stopping fence 13. The fastener 20 includes a first internal face 21 and a first external face 22, wherein the first internal face 21 has two opposite fourth tabs 211 extending therefrom, as shown in FIG. 6. The holder 1a further includes a second rotary shaft 70 and a second torsion spring 80. The second rotary shaft 70 is configured to rotatably connect with the two third tabs 133 and the two fourth tabs 211 so that the fastener 20 is rotated relative to the second stopping fence 13 along the second shaft 70. The second torsion spring 80 is fitted on the second rotary shaft 70, wherein a first end of the second torsion spring 80 is biased against the second stopping fence 13, and a second end of the second torsion spring 80 abuts against the fastener 20 so that the fastener 20 is pushed by the second torsion spring 80 to stay at the fastening position P1 when not being pressed, as illustrated in FIG. 7.

With reference to FIG. 7, the fixer 34 of the movable cover 30 is a hook and has a first hooking portion 341, a recess 342 defined adjacent to the first hooking portion 341, and a first tilted face 343 formed on the first hooking portion 341. The first external face 22 of the fastener 20 has a pressing portion 221 formed on a first end of the first external face 22 and has a second hooking portion 212 extending from a second end of the first external face 22. Referring to FIGS. 6 and 7, the second hooking portion 212 has a second tilted face 213 defined thereon so that when the movable cover 30 is rotatably closed, the fastener 20 is forced by the first tilted face 343 to rotate to the unfastening position P2 along the second rotary shaft 70, and the second hooking portion 212 slides into the recess 342 to hook with the first hooking portion 341. The pressing portion 211 is pressed by a user to force the fastener 20 to rotate to the unfastening position P2.

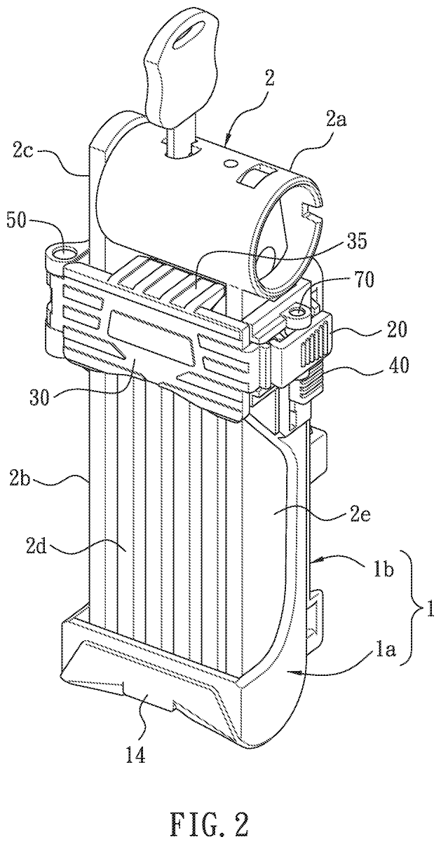

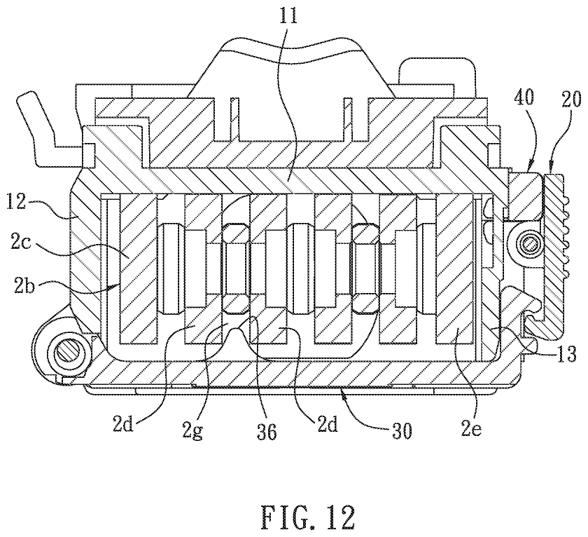

As shown in FIG. 5, the collapsible portion 2b of the folding lock 2 has a coupling rod 2c, multiple posts 2d, and a moving column 2e. The coupling rod 2c is connected on a first side of the head portion 2a, the moving column 2e is movably locked on a second side of the head portion 2a, and the multiple posts 2d are collapsibly retracted between the coupling rod 2c and the moving column 2e. A slit 2f is defined among the head portion 2a, the coupling rod 2c, the multiple posts 2d, and the moving column 2e. As illustrated in FIG. 12, multiple gaps 2g are defined among the coupling rod 2c, the moving column 2e, and the multiple posts 2d respectively. The collapsible portion 2b is put into the accommodation space 15 of the body 10 via the first opening 151 or/and the second opening 152 so that the head portion 2a extends out of the first opening 151, as illustrated in FIG. 2. The movable cover 30 further includes an insertion 35 extending from an inner wall thereof and inserted into the slit 2f so as to stop a removal of the folding lock 2 from the first opening 151. The movable cover 30 further includes a positioning protrusion 36 extending from the inner wall thereof so as to be fixed in one of the multiple gaps 2g and to fix the folding lock 2, as shown in FIG. 12.

With reference to FIG. 9, the guide portion 132 of the second stopping fence 13 has two notches 132a which communicate with each other. The latch 40 includes a second internal face 41 and a second external face 42. The second internal face 41 has two slidable blocks 411 limited in the two notches 132a individually and sliding between the locking position P3 and the unlocking position P4 along the two notches 132a. As shown in FIG. 10, when the two slidable blocks 411 are located at the locking position P3, an operation part 43 of the latch 40 is inserted into a spacing 100 between the pressing portion 221 and the second stopping fence 13 to stop the fastener 20 being pressed. As illustrated in FIG. 11, when the slidable blocks 411 are located at the unlocking position P4, the operation part 43 of the latch 40 is removed from the spacing 100 to allow the fastener 20 being pressed. Furthermore, the second external face 42 is pushed by the user.

With reference to FIG. 8, the second internal face 41 of the latch 40 further has a first locating trench 412 and a second locating trench 413. Referring to FIG. 4, the second stopping fence 13 further has a first rib 134 and a second rib 135 arranged on an outer wall of the second stopping fence 13 so that when the latch 40 is slid to the unlocking position P4, the first trench 412 is retained with the first rib 134, and the second trench 135 is retained with the second rib 135. As shown in FIG. 11, when the latch 40 is slid to the locking position P3, the second trench 413 is retained with the first rib 134, and a lower rim 44 of the latch 40 is retained with the second rib 135 so that the latch 40 is fixed at the locking position P3 and the unlocking position P4 by using the first trench 412, the first rib 134, the second trench 413, and the second rib 135, as illustrated in FIG. 10.

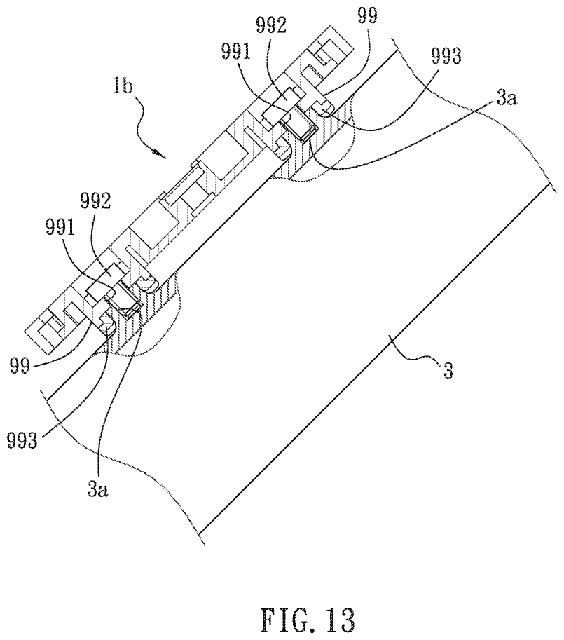

With reference to FIG. 3, the mounting 2 further includes a fixing plate 1b mounted on a bicycle frame, such as a down tube 3, as shown in FIG. 13, and the backing 11 is rotated to connect on the fixing plate 1b.

A rotation structure is defined between the fixing plate 1b and the backing 11 of the body 10 so that the body 10 is rotated leftward or rightward relative to the fixing plate 1b. Referring to FIG. 3, the rotation structure includes two arcuate tracks 111 respectively formed on an upper portion and a lower portion of a rear surface of the backing 11, two arcuate troughs 91 respectively formed on an upper portion and a lower portion of a rear surface of the fixing plate 1b so as to engage with the two arcuate tracks 111 individually, and a joining bolt 92 configured to rotatably connect the backing 11 with the fixing plate 1b.

As shown in FIGS. 3, 15, and 16, the fixing plate 1b has a limitation projection 93 flexibly expended and retracted so as to limit a rotation angle of the body 10 relative to the fixing plate 1b. The backing 11 further has a first cutout 112 formed in an arch shape. The fixing plate 1b has a second cutout 94 defined on a front surface thereof so as to receive the limitation projection 93, and the limitation projection 93 has a concavity 931 formed on a bottom thereof and configured to receive a first compression spring 95 so that a top of the limitation projection 93 is pushed by the first compression spring 95 to move into the first cutout 112, thus limiting the rotation angle of the body 10 relative to the fixing plate 1b. After the limitation projection 93 is pressed to remove from the first cutout 112, the two arcuate tracks 111 of the backing 11 are removed from the two arcuate troughs 91 respectively, and the joining bolt 92 is detachable so as to remove the body 10 from the fixing plate 1b.

With reference to FIGS. 3, 15, and 16, a rotatable control member 96 is fixed between the front surface of the fixing plate 1b and the rear surface of the backing 11 so that when the body 10 is flushed with the fixing plate 1b, it is locked.

The backing 11 further has an orifice 113 defined on the rear surface thereof. The fixing plate 1b further has a third cutout 94 defined on the front surface thereof so as to accommodate the rotatable control member 96, and the third cutout 97 has two opposite defining portions 971.

The rotatable control member 96 includes a third internal face 961, a third external face 962, an inner segment 963, and an outer segment 964. The inner segment 963 has two first pillars 965 respectively fixed in the two defining portions 971 so as to form a rotation fulcrum. The third internal face 961 has a second pillar 966, and the third external face 962 has a third pillar 967 extending outward, wherein when the body 10 is flushed with the fixing plate 1b, the third pillar 967 corresponds to the orifice 113 of the backing 11. The rotatable control member 96 further includes a second compression spring 98, wherein a first end of the second compression spring 98 is fitted on the second pillar 966, and a second end of the second compression spring 98 contacts with the third cutout 97, such that the second compression spring 98 pushes the rotatable control member 96 to rotate along the fulcrum to force the third pillar 967 to insert into the orifice 113, thus flushing the body 10 with the fixing plate 1b. The outer segment 964 has a drive portion 968 pressed by the user to drive the rotatable control member 96 to revolve along the fulcrum, hence the third pillar 967 is detached from the orifice 113 to rotate the body 10 leftward or rightward relative to the fixing plate 1b.

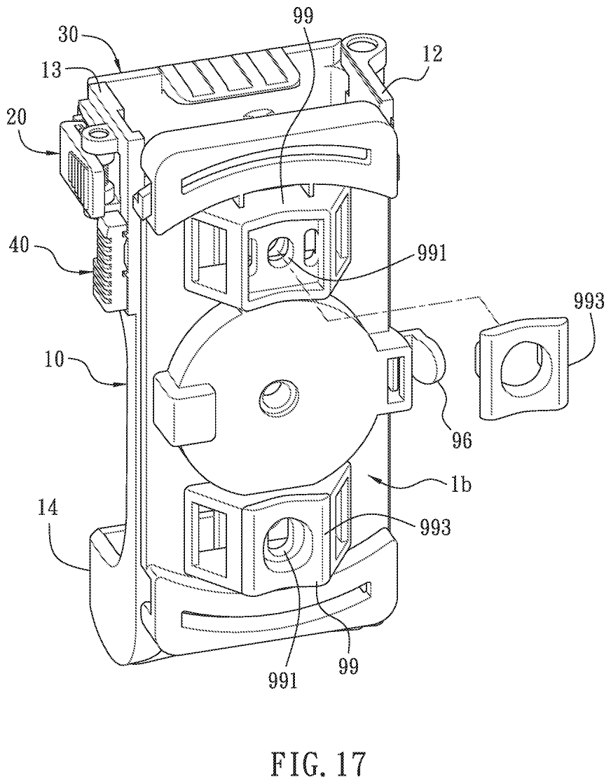

Referring to FIGS. 13 and 17, the fixing plate 1b further has two securing projections 99 respectively extending from an upper portion and a lower portion of the rear surface of the fixing plate 1b, and the two securing projections 99 have two elongated holes 991 respectively accommodating two screw bolts 992 which are screwed with two threaded holes 3a of the down tube 3 individually. The two securing projections 99 individually have two washers 993 made of rubber so as to protect the two securing projections 99 and the down tube 3.

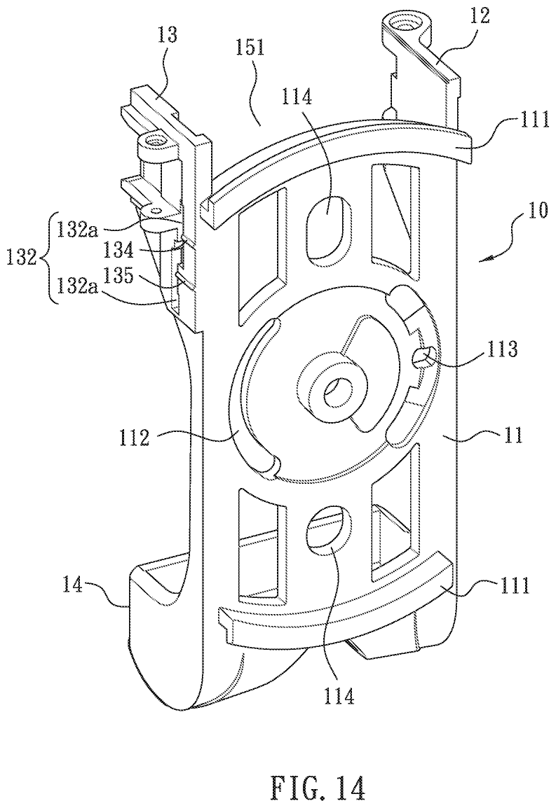

As shown in FIGS. 3, 13, and 14, the backing 11 of the body 10 further has two hollow holes 114 respectively corresponding to the two elongated holes 991, such that the two screw bolts 992 are respectively inserted through the two hollow holes 114 and the two elongated holes 991 to screw with the two threaded holes 3a without removing the holder 1a and the fixing plate 1b.

The two securing projections 99 respectively have two through holes 994 so that various bands or hook-and-loop fasteners are inserted through the two through holes 994 to tie the fixing plate 1b on any tubes of the bicycle frame except for the down tube 3.

The mounting 1 is fixed on a top of the down tube 3 in advance so as to fix or to detach the folding lock 2. For example, the latch 40 is pushed to the unlocking position P4 so as to unfasten the fastener 20, and the fastener 20 is pressed to rotate to the unfastening position P2, hence the first hooking portion 341 of the movable cover 30 is removed from the second hooking portion 212 of the fastener 20 and is opened automatically, and the movable cover 30 is pushed by the first torsion spring 60 to remove from the fastener 20, as shown in FIG. 1, thus opening the second opening 152 and fixing the folding lock 2 by ways of the holder 1a.

With reference to FIG. 5, the head portion 2a of the folding lock 2 is put into the accommodation space 15 of the holder 1a via the second opening 152 or/and the first opening 151, the folding lock 2 is slid downward so that the head portion 2a is received in the receiving groove 141 of the holding portion 14. Thereafter, the movable cover 30 is rotated so that the second hooking portion 212 of the fastener 20 is pushed by the second torsion spring 80 to hook with the first hooking portion 341 of the movable cover 30, and the latch 40 is pushed to the locking position P3 to lock the fastener 20, as illustrated in FIG. 10, thus fixing the folding lock 2.

Referring to FIG. 11, the latch 40 is pushed to the unlocking position P4 to unlock the fastener 20, and the fastener 20 is pressed so that the first hooking portion 341 of the movable cover 30 is detached from the second hooking portion 212 of the fastener 20 and is opened, as shown in FIG. 7. Referring further to FIG. 1, the folding lock 2 is lifted so that the head portion 2a is removed from the receiving groove 141, and the folding lock 2 is detached from the accommodation space 15 of the holder 1a via the second opening 152 or/and the first opening 151.

In case the folding lock 2 is not fixed or removed easily, the holder 1a is rotated leftward or rightward to overcome this problem. For example, as illustrated in FIG. 16, the drive portion 968 of the rotatable control member 96 is pressed by the user so that the third pillar 967 is detached from the orifice 113 to rotate the holder 1a leftward or rightward relative to the fixing plate 1b, thus fixing or removing the folding lock 2 easily.

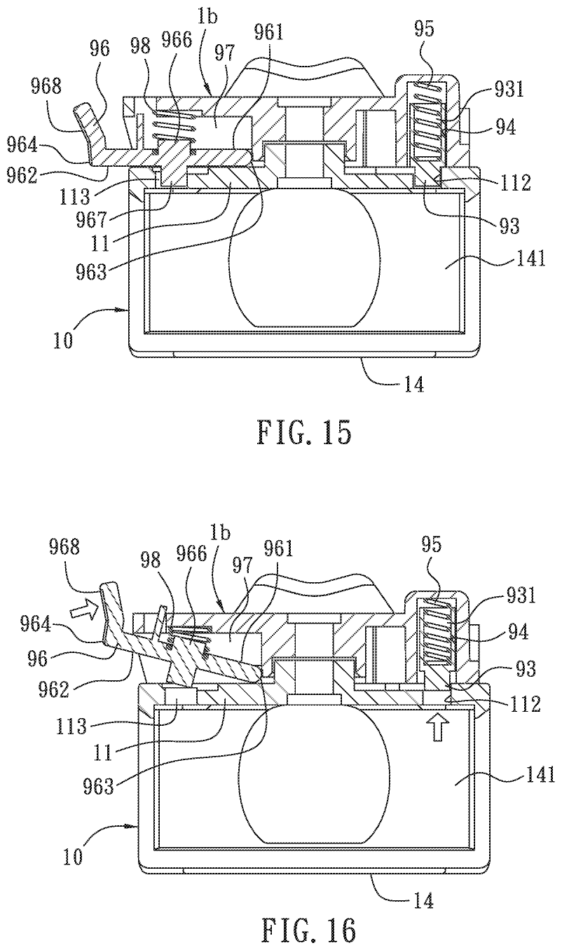

Thereafter, the holder 1a is rotated to flush with the fixing plate 1b, as shown in FIG. 2, and the third pillar 967 of the rotatable control member 96 is pushed by the second compression spring 98 to retain into the orifice 113 of the backing 11, as shown in FIG. 15. Thereby, the movable cover 30 is rotatably closed or opened to fix or remove the folding lock 2 easily.

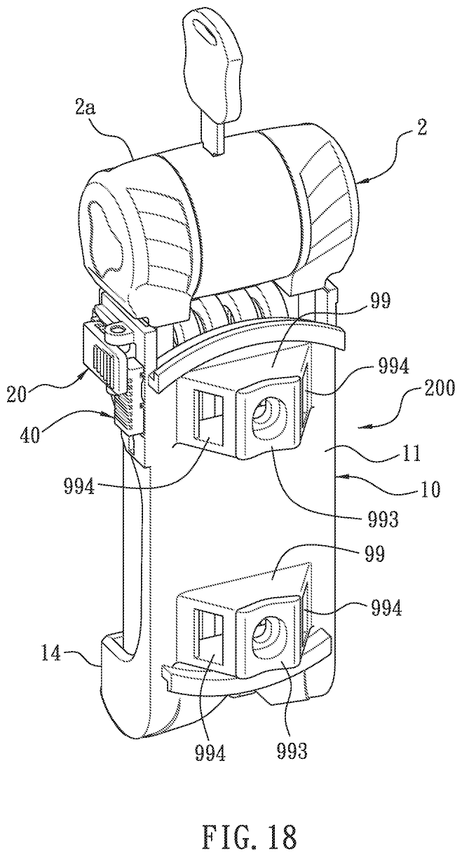

With reference to FIG. 18, in a second embodiment, a mounting 200 does not include the fixing plate 1b of the first embodiment. For example, the backing 11 of the body 10 has two securing projections 99 formed on the rear surface thereof, and the two securing projections 99 have two elongated holes 991, two screw bolts 992, two washers 993, and two through holes 994 respectively, thus simplifying the mounting 1 and reducing fabrication cost. When the mounting 200 is fixed on the bicycle frame, the body 10 is not rotated leftward or rightward relative to the fixing plate 1b. However, the folding lock 2 is fixed or removed easily via the second opening 152 or/and the first opening 151.

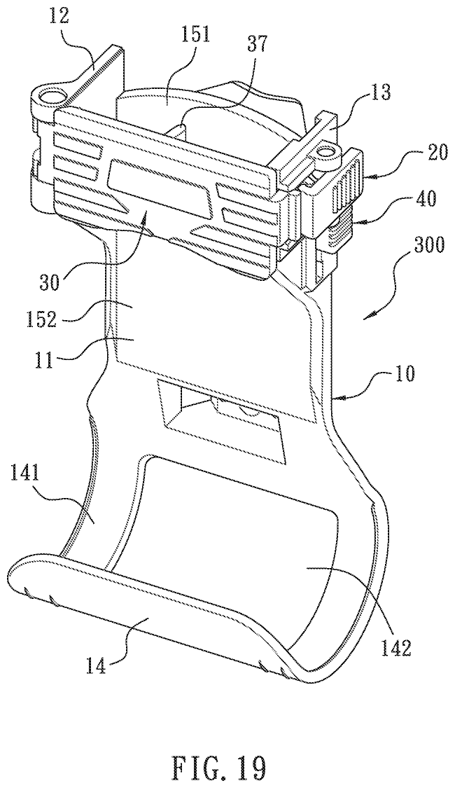

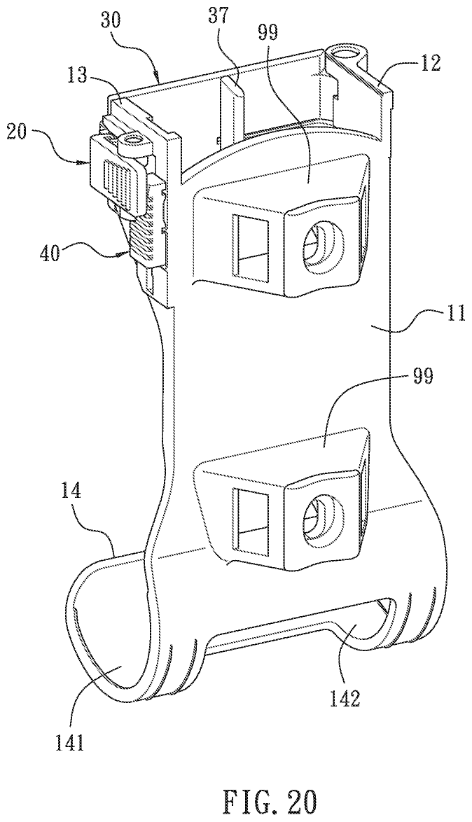

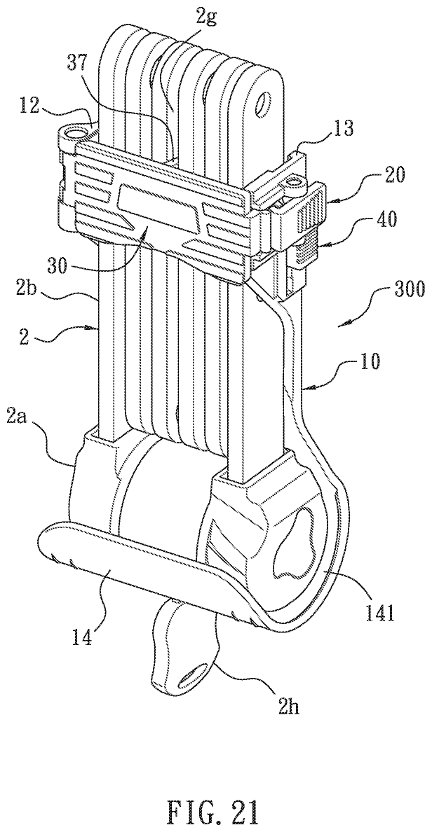

With reference to FIGS. 19-21, a difference of a mounting 300 of a third embodiment from that of the second embodiment comprises:

a head portion 2a of the locking lock 2 being fixed by being faced downward. In other words, a receiving groove 141 of the holding portion 14 corresponds to a shape and a size of at least one part of the head portion 2a so as to fix or remove the head portion 2a. The holding portion 14 has two open peripheries so that when the movable cover 30 is rotatably opened, the top of the collapsible portion 2b of the folding lock 2 is rotated out of the second opening 152 to detach from the first opening 151 above the first stopping fence 12 and the second stopping fence 13, and the folding lock 2 is slid out of the body 10 horizontally or is removed out of the second opening 152 obliquely.

The receiving groove 141 has a depression 142 defined on a bottom thereof so that a key 2h on the head portion 2a is extended out of the depression 142.

The folding lock 2 is fixed by facing the holding portion 2b upward and does not have the slit 2f of the first and second embodiments. Thereby, the insertion 35 of the first and second embodiments is eliminated from the movable cover 30, and an inserting sheet 37 is configured to replace the positioning protrusion 36 of the first and second embodiments so as to be accommodated into one of the multiple gaps 2g, thus fixing the folding lock 2. It is to be noted that the folding lock is mounted stably when facing the head portion 2a downward.

Accordingly, the mounting of the present invention has advantages as follows:

1. A width of each of the second opening 152 and the first opening 151 is more than that of the conventional opening so that the folding lock is fixed or removed easily and quickly.

2. The movable cover 30 stops the folding lock 2 being removed via the second opening 152 and the first opening 151 by ways of the insertion 35 and the positioning protrusion 36. The fastener 20 is locked or unlocked by using the latch 40 so as to avoid the movable cover 30 being opened as riding a bicycle.

3. The movable cover 30 is detached from the fastener 20 and is opened automatically by ways of the first torsion spring 60 after pressing the fastener 20. Furthermore, the fastener 20 is locked with the movable cover 30 automatically by using the second torsion spring 80, when the movable cover 30 is rotatably closed.

4. The folding lock 2 is put into or is removed from the accommodation space 15 of the holder 1a via the second opening 152 or/and the first opening 151 flexibly. Preferably, the mounting 200 does not include the fixing plate 1b of the first embodiment so as to simplify the mounting and to reduce the fabrication cost.

5. The mounting 1 includes the holder 1a and the fixing plate 1b so that the rotation structure is defined between the fixing plate 1b and the backing 11 of the body 10, and the body 10 is rotated leftward or rightward relative to the fixing plate 1b, thus enhancing fixing or removing flexibility.

6. The mountings of the present invention are satisfied with different using requirements of the folding lock. In the first embodiment, the head portion 2a of the folding lock 2 is faced upward to fix the folding lock 2 to the mounting 1, and the holder 1a is rotated leftward or rightward relative to the fixing plate 1b to fix or to remove the folding lock 2 easily. The mounting 200 of the second embodiment does not include the fixing plate 1b of the first embodiment, and the holder 1a of the mounting 200 is fixed on the bicycle frame directly, thus simplifying the mounting 200. In the third embodiment, the head portion 2a of the folding lock 2 is faced downward to fix the folding lock 2 to the mounting 300.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A mounting including a holder configured to accommodate a folding lock, and the holder comprising:
a body including a backing, a first stopping fence extending from a first side of the backing, a second stopping fence extending from a second side of the backing opposite to the first side of the backing, a holding portion extending from a bottom of backing, and an accommodation space defined by the backing, the first stopping fence, the second stopping fence, and the holding portion so as to accommodate the folding lock; the holding portion accommodating a bottom of the folding lock; the first stopping fence having a first rotatable connection portion, and the second stopping fence having a second rotatable connection portion and a guide portion;
a fastener rotatably connected with the second rotatable connection portion of the second stopping fence and being rotated to a fastening position and an unfastening position;
a movable cover including a first fringe and a second fringe, wherein the first fringe has a third rotatable connection portion which is rotatably connected with the first rotatable connection portion of the first stopping fence so that the movable cover is rotatably closed or opened; wherein the second fringe has a fixer extending outward so that when the movable cover is rotatably closed, the fixer fastens with the fastener at the fastening position;
a latch mounted on the guide portion of the second stopping fence and being movable between a locking position and an unlocking position, wherein when the latch is located at the locking position, the latch stops the fastener being rotated to the unfastening position, wherein when the latch is located at the unlocking position, the latch allows the fastener to be rotated to the fastening position.

2. The mounting as claimed in claim 1, wherein a receiving groove is defined by the holding portion and the backing and is a part of the accommodation space so as to receive the bottom of the folding lock.

3. The mounting as claimed in claim 1, wherein the first rotatable connection portion has two opposite first tabs extending from the first stopping fence; the third rotatable connection portion has two opposite second tabs extending from the first fringe of the movable cover, and the holder further includes a first rotary shaft configured to rotatably connect with the two first tabs and the two second tabs so that the movable cover is rotated relative to the first stopping fence.

4. The mounting as claimed in claim 3, wherein the holder further includes a first torsion spring fitted on the first rotary shaft, wherein a first end of the first torsion spring is inserted into the first stopping fence, and a second end of the first torsion spring abuts against the movable cover so that when the movable cover is rotated to the unfastening position after pressing the fastener, the movable cover is pushed by the first torsion spring to open automatically.

5. The mounting as claimed in claim 1, wherein the second rotatable connection portion has two opposite third tabs extending from the second stopping fence; the fastener includes a first internal face and a first external face, wherein the first internal face has two opposite fourth tabs extending therefrom; the holder further includes a second rotary shaft and a second torsion spring; the second rotary shaft is configured to rotatably connect with the two third tabs and the two fourth tabs so that the fastener is rotated relative to the second stopping fence along the second stopping fence; the second torsion spring is fitted on the second rotary shaft, wherein a first end of the second torsion spring is biased against the second stopping fence, and a second end of the second torsion spring abuts against the fastener so that the fastener is pushed by the second torsion spring to stay at the fastening position when not being pressed.

6. The mounting as claimed in claim 5, wherein the fixer of the movable cover is a hook and has a first hooking portion, a recess defined adjacent to the first hooking portion, and a first tilted face formed on the first hooking portion; the first external face of the fastener has a pressing portion formed on a first end of the first external face and has a second hooking portion extending from a second end of the first external face; the second hooking portion has a second tilted face defined thereon so that when the movable cover is rotatably closed, the fastener is forced by the first tilted face to rotate to the unfastening position along the second rotary shaft, and the second hooking portion slides into the recess to hook with the first hooking portion; the pressing portion is pressed by a user to force the fastener to rotate to the unfastening position.

7. The mounting as claimed in claim 1, wherein the folding lock includes a head portion and a collapsible portion; the collapsible portion of the folding lock has a coupling rod, multiple posts, and a moving column; the coupling rod is connected on a first side of the head portion, the moving column is movably locked on a second side of the head portion, and the multiple posts are collapsibly retracted between the coupling rod and the moving column, wherein a slit is defined among the head portion, the coupling rod, the multiple posts, and the moving column, wherein multiple gaps are defined among the coupling rod, the moving column, and the multiple posts respectively; the collapsible portion is put into the accommodation space of the body via the first opening or/and the second opening so that the head portion extends out of the first opening; the movable cover further includes an insertion extending from an inner wall thereof and inserted into the slit so as to stop a removal of the folding lock from the first opening, wherein the movable cover further includes a positioning protrusion extending from the inner wall thereof so as to be fixed in one of the multiple gaps and to fix the folding lock.

8. The mounting as claimed in claim 6, wherein the guide portion of the second stopping fence has two notches which communicate with each other; the latch includes a second internal face and a second external face; the second internal face has two slidable blocks limited in the two notches individually and sliding between the locking position and the unlocking position along the two notches, when the two slidable blocks are located at the locking position, an operation part of the latch is inserted into a spacing between the pressing portion and the second stopping fence to stop the fastener being pressed, when the slidable blocks are located at the unlocking position, the operation part of the latch is removed from the spacing to allow the fastener being pressed; the second external face is pushed by the user.

9. The mounting as claimed in claim 1, wherein the guide portion of the second stopping fence has two notches which communicate with each other; the latch includes a second internal face and a second external face; the second internal face has two slidable blocks limited in the two notches individually and sliding between the locking position and the unlocking position along the two notches; the second external face is pushed by the user.

10. The mounting as claimed in claim 9, wherein the second internal face of the latch further has a first locating trench and a second locating trench; the second stopping fence further has a first rib and a second rib arranged on an outer wall of the second stopping fence; when the latch is slid to the unlocking position, the first trench is retained with the first rib, and the second trench is retained with the second rib; when the latch is slid to the locking position, the second trench is retained with the first rib, and a lower rim of the latch is retained with the second rib so that the latch is fixed at the locking position and the unlocking position by using the first trench, the first rib, the second trench, and the second rib.

11. The mounting as claimed in claim 1 further comprising a fixing plate mounted on a bicycle frame, and the backing of the body is rotated to connect on the fixing plate.

12. The mounting as claimed in claim 11, wherein a rotation structure is defined between the fixing plate and the backing of the body so that the body is rotated leftward or rightward relative to the fixing plate.

13. The mounting as claimed in claim 12, wherein the rotation structure includes two arcuate tracks respectively formed on an upper portion and a lower portion of a rear surface of the backing, two arcuate troughs respectively formed on an upper portion and a lower portion of a rear surface of the fixing plate so as to engage with the two arcuate tracks individually, and a joining bolt configured to rotatably connect the backing with the fixing plate.

14. The mounting as claimed in claim 11, wherein the fixing plate has a limitation projection flexibly expended and retracted so as to limit a rotation angle of the body relative to the fixing plate.

15. The mounting as claimed in claim 14, wherein the backing further has a first cutout formed in an arch shape; the fixing plate has a second cutout defined on a front surface thereof so as to receive the limitation projection, and the limitation projection has a concavity formed on a bottom thereof and configured to receive a first compression spring so that a top of the limitation projection is pushed by the first compression spring to move into the first cutout, thus limiting the rotation angle of the body relative to the fixing plate; the limitation projection is pressed to remove from the first cutout.

16. The mounting as claimed in claim 11, wherein a rotatable control member is fixed between the front surface of the fixing plate and the rear surface of the backing so that when the body is flushed with the fixing plate, the body is locked.

17. The mounting as claimed in claim 16, wherein the backing further has an orifice defined on the rear surface thereof; the fixing plate further has a third cutout defined on the front surface thereof so as to accommodate the rotatable control member, and the third cutout has two opposite defining portions; the rotatable control member includes a third internal face, a third external face, an inner segment, and an outer segment; the inner segment has two first pillars respectively fixed in the two defining portions so as to form a rotation fulcrum; the third internal face has a second pillar; and the third external face has a third pillar extending outward, wherein when the body is flushed with the fixing plate, the third pillar corresponds to the orifice of the backing; the rotatable control member further includes a second compression spring, wherein a first end of the second compression spring is fitted on the second pillar, and a second end of the second compression spring contacts with the third cutout, such that the second compression spring pushes the rotatable control member to rotate along the fulcrum to force the third pillar to insert into the orifice, thus flushing the body with the fixing plate; the outer segment has a drive portion pressed by a user to drive the rotatable control member to revolve along the fulcrum, hence the third pillar is detached from the orifice to rotate the body leftward or rightward relative to the fixing plate.

18. The mounting as claimed in claim 11, wherein the fixing plate further has two securing projections respectively extending from an upper portion and a lower portion of the rear surface of the fixing plate, and the two securing projections have two elongated holes respectively accommodating two screw bolts which are screwed with two threaded holes of a down tube individually.

19. The mounting as claimed in claim 18, wherein the two securing projections individually have two washers configured to contact with the down tube.

20. The mounting as claimed in claim 18, wherein the backing of the body further has two hollow holes respectively corresponding to the two elongated holes, such that the two screw bolts are respectively inserted through the two hollow holes and the two elongated holes to screw with the two threaded holes.

21. The mounting as claimed in claim 18, wherein the two securing projections respectively have two through holes so that various bands or hook-and-loop fasteners are inserted through the two through holes to tie the fixing plate on any tubes of the bicycle frame.

22. The mounting as claimed in claim 1, wherein the fixing plate further has two securing projections respectively extending from an upper portion and a lower portion of a rear surface of the fixing plate, and the two securing projections have two elongated holes respectively accommodating two screw bolts which are screwed with two threaded holes of a down tube of a bicycle frame individually.

23. The mounting as claimed in claim 22, wherein the two securing projections individually have two washers configured to contact with the down tube.

24. The mounting as claimed in claim 22, wherein the two securing projections respectively have two through holes so that various bands or hook-and-loop fasteners are inserted through the two through holes to tie the fixing plate on any tubes of the bicycle frame.

25. The mounting as claimed in claim 1, wherein the folding lock includes a head portion and a collapsible portion; a receiving groove of the holding portion corresponds to a shape and a size of at least one part of the head portion so as to fix or remove the head portion, and the holding portion has two open peripheries; the receiving groove has a depression defined on a bottom thereof so that a key on the head portion is extended out of the depression.
